(19) United States
(12) Patent Application Publication
(10) Pub. No.: US 2005/0022887 A1
(43) Pub. Date: Feb. 3, 2005

(54) Flow diverter arrangement

(75) Inventor: Donald K. Hagar, Almont, CO (US)

Correspondence Address: FOLEY AND LARDNER;SUITE 500, 3000 K STREET NW, WASHINGTON, DC, 20007, US

(73) Assignee: Damper Design, Inc.

(21) Appl. No.: 10/630,974

(22) Filed: Jul. 31, 2003

(51) Int. Cl. F16K 11/072

(52) U.S. Cl. 137/625.44

(57) ABSTRACT

A single flow control element is pivotally mounted in a housing and arranged to be selectively rotated from a first flow directing position, wherein the gas flow is by-passed and prevented from entering a gas treatment device, to a second flow directing position wherein the gas is directed through the gas treatment device. In the first and second flow directing positions, the edges of the flow directing element respectively cooperate with first and second sets of seal seats to defined interfaces into which air under pressure is introduced. This air is pressurized to a level whereat air curtains are formed to prevent leakage of gas past the flow control element and enable a man-safe zone to be established in the housing while the flow control element is in the position in which the by-pass flow path is established. The flow control element has a dual wall (bi-plane) construction having a pair of spaced walls which are offset with respect to one another so as to provide an essentially trapezoidal cross section.

### BACKGROUND OF THE INVENTION

1. Field of the Invention

The present invention relates generally to a gas flow diverter for a large scale SCR (selective catalytic reduction) or the like type of arrangement and more specifically to a gas flow diverter arrangement that requires only one flow control element and that enables toxic gas free conditions to be selectively established therein.

2. Description of the Prior Art

Various structures have been proposed for switching the flow of gas being exhausted from large scale hydrocarbon-fuel combusting furnaces/devices used in connection with large scale generation of electrical power, and the like. However, these arrangements inevitably require complex single/multiple blades (flow control elements) to switch between a flow situation wherein the exhaust gas is passed over a catalytic converting material (e.g. during summer) and is by-passed during colder weather (e.g. during winter) thus leading to complex and expensive structures.

The establishment of a toxic gas free zone within the diverter also adds to the complexity and cost of the arrangement.

### SUMMARY OF THE INVENTION

The present invention is directed to a flow diverter arrangement wherein, in order to enable gas flow to be selectively directed along a first flow path in which a gas treatment device is by-passed to an exhaust and a second flow path wherein the gas is directed through the gas treatment device and returned to the exhaust. This is achieved by an arrangement having a single flow control element that is pivotally mounted in a housing and arranged to be selectively rotated from a first flow directing position wherein the gas flow is by-passed and prevented from entering the inlet or outlet of the gas treatment device, to a second flow directing position wherein the gas is directed through the gas treatment device. In the first and second flow directing positions, the edges of the flow directing element respectively cooperate with first and second sets of seal seats to defined interfaces into which air under pressure is introduced. This air is pressurized to a level whereat air curtains are formed to prevent leakage of gas past the flow control element and to enable a toxic gas free zone to be established in the housing while the flow control element is in the position in which the by-pass flow path is established.

More specifically a first aspect of the invention resides in a gas flow diverter comprising: a housing having first and second inlets and first and second outlets; a flow control element having first and second spaced walls each having first and second opposed edges, the flow control element being disposed in the housing and pivotal about an axis between first and second flow control positions, the first flow control position partitioning the housing so that the first inlet is isolated from the first outlet and the second inlet is isolated from the second outlet and so that a first flow path is established between the first inlet and the second outlet, the second flow control position partitioning the housing so that the first inlet is isolated from the second outlet and the second inlet is isolated from the second outlet and so that a second flow path is established; first and second pairs of seal seats against which the first and second opposed edges of the flow control element are operatively engageable when the flow control element assumes the first and second flow control positions respectively; and an air supply for supplying air under pressure into a space defined between the first and second walls to establish air flows between at least the first and second edges of the flow control element and the first pairs of seats when the flow element is in the first flow control position and between the first and second edges of the flow control element and the second pair of seats when the flow control element is in the second flow control position.

With the above arrangement a toxic gas free zone is established in the housing between the flow control element in the first flow control position and the second inlet and second outlet.

In more detail, the gas flow diverter as set forth above is such that the first outlet is adapted for connection with a noxious component treatment device and to deliver gas containing a noxious component into the treatment device, the second inlet is adapted to deliver gas which has passed through the noxious component treatment device into the housing, the first inlet is adapted to receive gas containing noxious component, and the second outlet is adapted for exhausting gas to the conduit that ultimately leads to the ambient atmosphere.

The air under pressure from the air supply has a pressure which is greater than the pressure in the first inlet port. Further, the first and second spaced walls are offset from one another so that the flow control element has an essentially trapezoidal cross-section.

Each of the first and second pairs of seal seats have a stepped configuration wherein a first step is lower than a second step. In connection with the first pair of seal seats, the first and second walls respectively have first and second opposite edges which are respectively provided with flexible seal members so that the flexible seal members on each of the leading edges of the first and second walls with respect to the direction of rotation of the flow control member about the axis of rotation, is such as to miss the respective first low steps of the first pair of seal seats and to engage the respective second high steps, and wherein the seal members on the trailing edges of the first and second walls with respect to the direction of rotation is such as to engage the first lower steps.

In connection with the second pair of seal seats, the first and second walls respectively have first and second opposite edges which are respectively provided with flexible seal members and wherein the flexible seal members on each of the leading edges of the first and second walls with respect to the direction of rotation of the flow control member about the axis of rotation, is such as to miss the respective first low steps of the second pair of seal seats and to engage the respective second high steps, and wherein the seal members on the trailing edges of the first and second walls with respect to the direction of rotation is such as to engage the first lower steps.

In this arrangement the second pair of seats is arranged so that each seat is rotatable from a first position wherein the first and second steps are directed toward an axis about which the flow control element is rotatable and a second position wherein the first and second steps are directed away from the axis.

A second aspect of the invention resides in a gas flow diverter comprising: a flow control element which is rotatable about an axis of rotation between a first flow directing position and a second flow directing position; first and second sets of seal seats disposed to cooperate with opposed edges of the flow control element when the flow control element is in the first and second flow control directing positions, respectively; and an air supply which supplies air under pressure to a first interfaces between the first set of seal seats and the flow control element when the flow control element is in the first flow control position and to second interfaces between the second set of seal seats and the flow control element when the flow control element is in the second flow control position.

In this arrangement the flow control element comprises a blade member comprising first and second spaced walls, and the first and second spaced walls of the blade member are offset with respect to each other and so that the blade member has an essentially trapezoidal cross-section when taken normally to the axis of rotation.

The first and second spaced walls of the blade member respectively have first and second sets of opposed edges which are provided respectively with first and second sets of flexible seal members. Further, the first and second sets of seal seats have a stepped configuration wherein each steps has a high ridge portion and a low ridge portion.

The flow control element is disposed in a housing having a first inlet, a first outlet, a second inlet and a second outlet, wherein the first flow directing position of the flow control element places isolates the first outlet from the first inlet, isolates the second inlet from the second outlet and places the first inlet and the first outlet in communication with one another, wherein the second flow directing position of the flow control element places the first inlet in communication with the first outlet and the second inlet in communication with the second outlet.

With the above arrangement a toxic gas free zone is established in the housing between the flow control element and the second inlet and the second outlet when the flow control element is in the first flow directing position.

A further aspect of the invention resides in a method of controlling gas flow comprising the steps of: dispositioning a flow control element in a first flow control position wherein a first flow path, which by-passes an exhaust gas treatment device, is established and wherein opposed edges of the flow control element juxtapose a first set of seal seats; introducing air under pressure into interfaces defined between the opposed edges of the flow control element and the pair of seal seats which are disposed in a housing in which the flow control element is pivotally disposed, and establishing first air flows which form a first air curtain arrangement; rotating the flow control element from the first flow control position to a second flow control position wherein a second flow path, which directs gas flow through the exhaust gas treatment device, is established and wherein the opposed edges of the-flow control element juxtapose a second set of seal seats; and introducing air under pressure into interfaces defined between the opposed edges of the flow control element and the second pair of seal seats establishing second air flows which form a second air curtain arrangement.

This method further comprises establishing a toxic gas free zone in a housing in which the flow control element is disposed by setting the flow control element in the first flow position and using the first flow control element and the first and second air curtain arrangements to exclude gas from the portion of the housing partitioned off by the flow control element.

### BRIEF DESCRIPTION OF THE DRAWINGS

The various features and attendant advantages of the embodiments of the invention will become more clearly appreciate as a detailed description thereof is given with reference to the appended drawings in which:

FIG. 1 is a schematic plan view of a diverter according to an embodiment of the invention showing a flow control element in a by-pass position wherein gases are prevented from flowing through a gas treatment device;

FIG. 2 is a schematic plan view similar to that shown in FIG. 1 wherein the flow control element is shown in a position wherein gas flow is directed through the gas treatment device;

FIG. 3 is an underside plan view of an embodiment of a diverter according to the invention showing the disposition of an air supply arrangement which is used in connection with supplying air under pressure to seal arrangements of the diverter;

FIG. 4 is a side view of the arrangement shown in FIG. 3 depicting the arrangement of the flow control element within a housing;

FIG. 5 is a side view showing the air supply arrangement and the manner it is connected with the housing in which the flow control element is operatively mounted;

FIG. 6 is a view showing a position limiting lever which is connected with a shaft on which the flow control element is mounted;

FIG. 7 is an underside plan view of the limiting lever depicted in FIG. 6 and which shows adjustment bolts which determine the limits of the pivotal movement of the flow control element;

FIG. 8 is a top plan view showing the manner in which air conduits associated with the air supply arrangement are connected to the housing in which the flow control element is mounted;

FIG. 9 is a plan view similar to the schematic view of FIG. 1 showing the flow control element in a by-pass position;

FIGS. 10 and 11 show details of the engagement of seals and fixed seal seats which establishes a seal between the edges of the flow control element and permit the formation of a first set of air curtains while the flow control element is in the by-pass position;

FIGS. 12 and 13 show the position of rotatable seal seats assumed while the flow control element is in the flow control position shown in FIG. 9;

FIG. 14 is a plan view similar to that depicted in FIG. 1 with the flow control element set to direct gas flow through the gas treatment device and with the seals of the flow control element engaged with the rotatable seal seats;

FIGS. 15 and 16 are enlarged views showing the manner in which rotatable seal seats are rotated into operative engagement with the seals provided on edges of the flow control element;

FIGS. 17 and 18 show details of the shaft about which the flow control element is rotated and the manner in which jamb seals which are provided along the upper and lower edges of the flow control element, slide continuously along the inner walls of the flow control element housing and provide a seal against gas leakage; and

FIG. 19 is a end view of a insulating can which is used to encloses the drive side and stub side ends of the shaft which is connected to a drive mechanism.

### DETAILED DESCRIPTION OF THE PREFERRED EMBODIMENTS

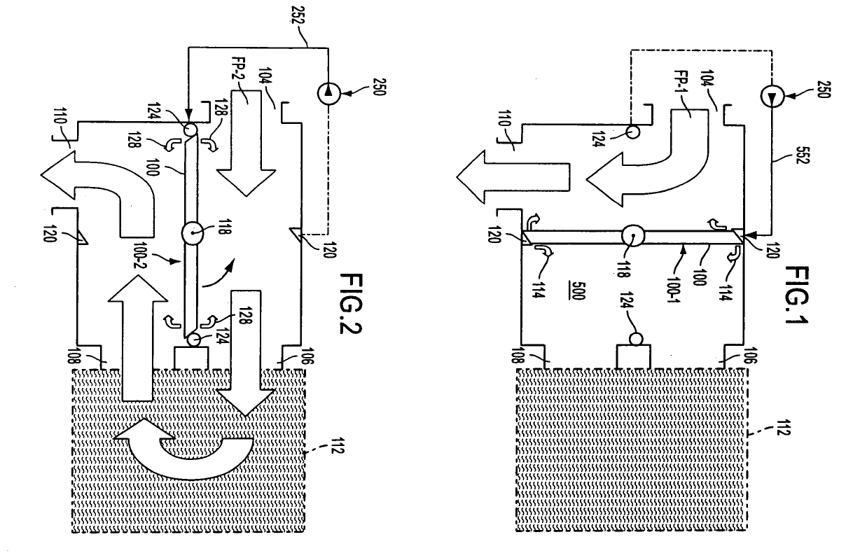

FIGS. 1 and 2 schematically depict the structure and operation of a first embodiment of the present invention. In this schematically depicted situation, an essentially rectangular flow control element or blade 100 is pivotally mounted within a housing 102. The housing is formed with a first inlet 104, a first outlet 106, a second inlet 108 and a second outlet 110.

Although not illustrated, the first inlet 104 is, merely by way of example, fluidly communicated with the exhaust of a coal/oil fired furnace, gas turbine, or the like type of power generation arrangement (not shown).

FIG. 1 shows the flow control element 100 in what shall be referred to as a first or by-pass flow directing position 100-1. In this position, a first flow control path FP-1 is established, and the housing 102 is partitioned so that the gas flow, which is introduced into the housing 102 through the first inlet 104, is prevented from flowing toward the first outlet 106 and instead directly flows to the second outlet 110. This first flow path FP-1 is such that a gas treatment device 112 is isolated from the gases which are introduced via the first inlet 104.

When the flow control element 100 is rotated to a second flow directing position 100-2 depicted in FIG. 2, a second flow path FP-2 is established. As shown in FIG. 2, this second flow path FP-2 is such that the gases that are introduced into the housing 102 via the first inlet 104 are directed to the first outlet 106 and into a gas treatment device 112 containing a catalyst or catalysts which are suitably supported on structures therein (schematically shown). The gases which has been subjected to treatment in the gas treatment device 112 are then introduced back into the housing 102 via the second inlet 108 and thereafter exhausted via the second outlet 110.

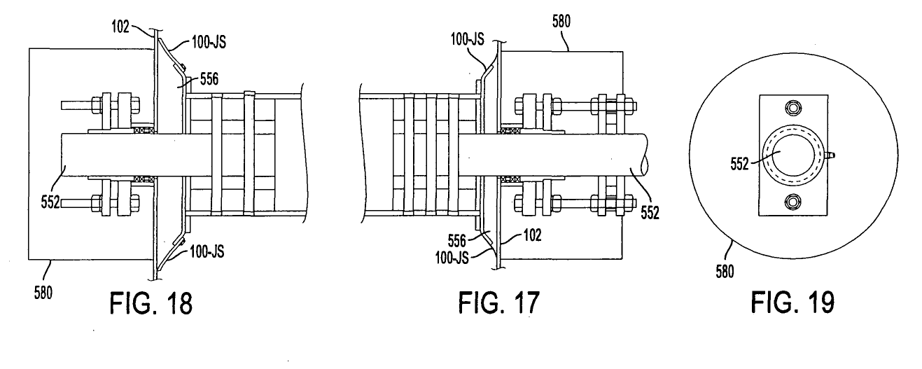

In the first flow directing position 100-1 a first set of air curtains 114 are established between the opposed edges of the flow control element which are parallel with the axis 118 about which the blade is rotatable, and a first pair of seal seats 120. For the sake of explanation, these opposed edges of the flow control element 100 will be referred to as the parallel edges 100-P, while the opposed edges, which interconnect the parallel edges, will be referred to as normal or sweep edges 100-S. These sweep edges 100-S are provided with so called “jamb seals” 100/JS (see FIGS. 17 and 18) which maintain constant sliding contact with the upper and lower interior wall surfaces of the housing 102 over which the jamb seals 100/JS slide during rotational movement of the flow control element 100. For further disclosure of these types of “Jamb Seals” reference may be had to U.S. Pat. No. 4,673,026 issues on Jun. 16, 1987 in the name of Hagar et al. The contents of this patent is hereby incorporated by reference.

The air curtains 114, denoted by the small curved flow arrows in FIG. 1, are established while the flow control element is in the first flow directing position, by delivering air under pressure from a source of air under pressure 250 to the spaces or interfaces defined between the parallel edges 100-P of the flow control element 100 and the first set of seal seats 120. In this embodiment, the first seal seats 120 are fixedly mounted in place on opposed inner walls of the housing 102.

When the flow control element 100 is rotated to its second flow directing position 100-2 shown in FIG. 2, the parallel edges 100-P of the flow control element 100 establish an operative relationship with a second pair of seal seats 124. Air under pressure from the source of air under pressure 250 is switched and supplied into the interfaces defined between the second pair of seal seats and the parallel edges of the flow control element, thus establishing a second set of air curtains 128.

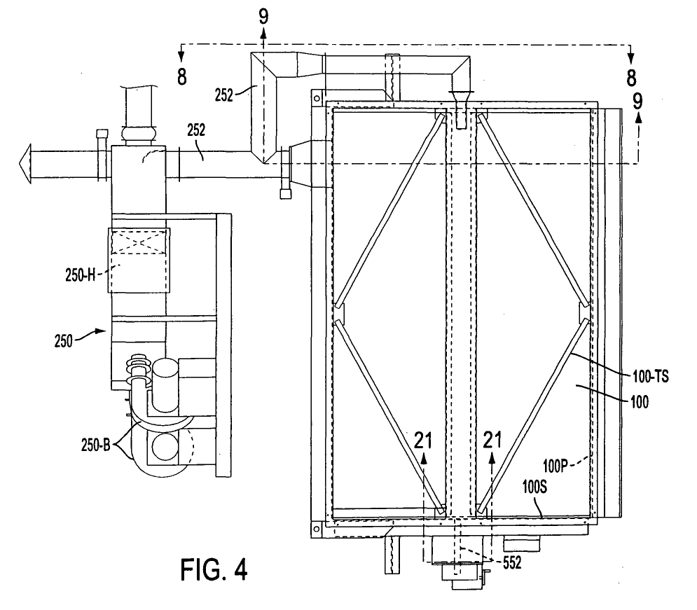

As will be noted, in this embodiment, the flow control element 100 takes the form of a so called “biplane blade” which has two spaced walls 100-W which are offset with respect to one another so that the cross-section is essentially trapezoidal when taken along a plane which passes normally through the axis 118 of rotation. The spaced walls are interconnected by a suitable truss structure 100-TS (see FIG. 4) which provides high rigidity and light weight.

The interior of the bi-plane blade 100 is such that air can move therewithin. This means that the interior can be pressurized by the supply of air from one side via one of the two interfaces that are established in each of the flow control positions and thus simultaneously supply air to all four edges of the blade.

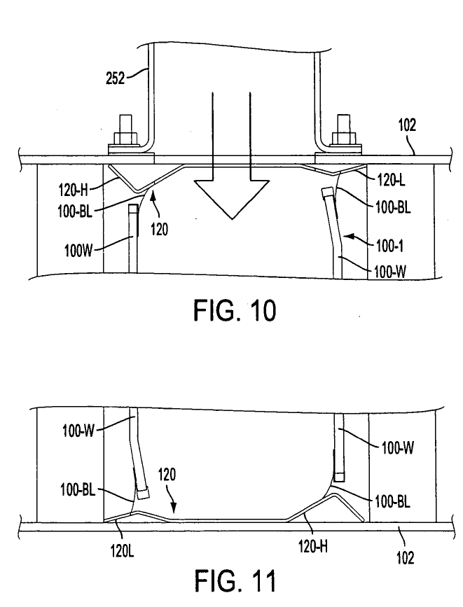

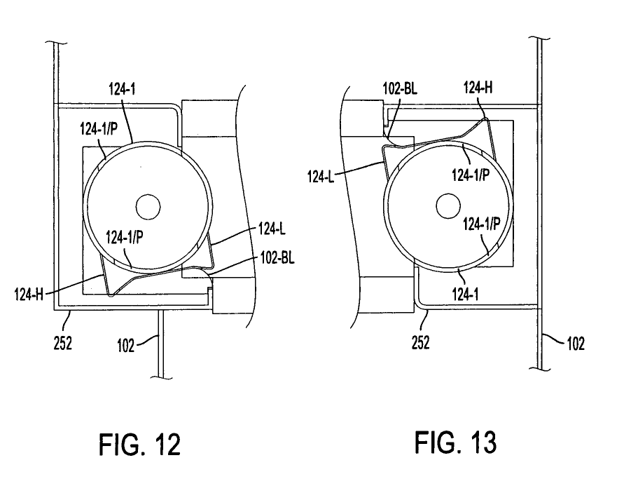

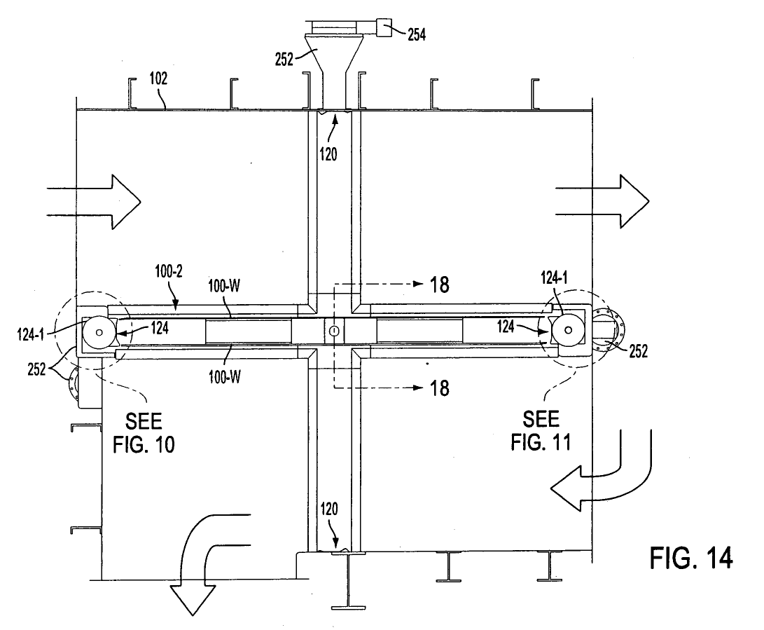

The fixed set of seats 120 are, as best seen in FIGS. 10 and 11, stepped so that each seat has an elongate high apex ridge portion 120-H and an elongate low apex ridge portion 120-L. Flexible metallic seal blades 100-BL which are connected to the edges of the biplane blade walls sweep against the respective apex ridges 120-H, 120-L.

With this arrangement, when the flow control element (biplane blade) 100 assumes the first flow control position 100-1, the flexible metallic blades 100-BL on the respective leading edges (with respect to the direction of movement) pass over the low apex ridges 120-L before sweeping against the high apex ridges 120-H. The flexible seal blades 100-BL on the trailing edges, on the other hand, are adapted to sweep directly against the low apex ridges 120L and to establish sealing contact therewith.

This double, spaced contact between the apex ridges 120-H, 120-L and the flexible metallic seal blades 100-BL alone provides a good sealing action and establishes a space or plenum into which air from the supply of air under pressure 250 can be delivered. Air escaping past the seal blades 100-BL forms the air curtains 114 when the flow control element 100 is in the first flow control position 100-1 and forms the air curtains 128 when the flow control element is in the second flow control position 100-2

The second set of rotatable seal seats 124, which have essentially the same configuration as the fixed seal seats 120, are mounted on elongate, tubular rotatable members 124-1 so that they may be rotated out of the way to positions where the bi-plane blade 100 can be pivoted to the second flow control position 100-2 without interference between the flexible metal blades and the high apex ridge portions on each of the second set of seal seats 124.

While the rotatable seal seats 124 are in the positions shown in FIGS. 12 and 13, flexible blade seals 102-BL which are mounted on the container 102, engage the low apex ridges 124-L and serve to maintain a seal which prevents leakage of air.

After the bi-plane blade has assumed the second flow control position 100-2, the seal arrangements rotated to the positions shown in FIGS. 14-16. This brings the high and low apex ridge portions 124H, 124L of each the seal seats 124 into appropriate contact with the flexible metal blades and establishes sealing conditions essentially identical with those illustrated in FIGS. 10 and 11. Under these conditions, the flexible blade seal 102-BL engage the peak portions of the high apex ridges 124-H in the illustrated manner and maintain their sealing effect with the rotatable valve seats 124.

Following this sealing condition being established, air under pressure is supplied into the space or plenum defined between the walls of the biplane-blade 100. In this embodiment, the air is supplied through the rotatable members 124-1 which are ported (provided with ports 124-1P) so that the communication between the interior of the bi-plane blade and a supply of air under pressure 250, is established when the rotatable members 124-1 are rotated to the positions wherein the seats 124 are directed toward each other and the edges of the bi-plane blade 100.

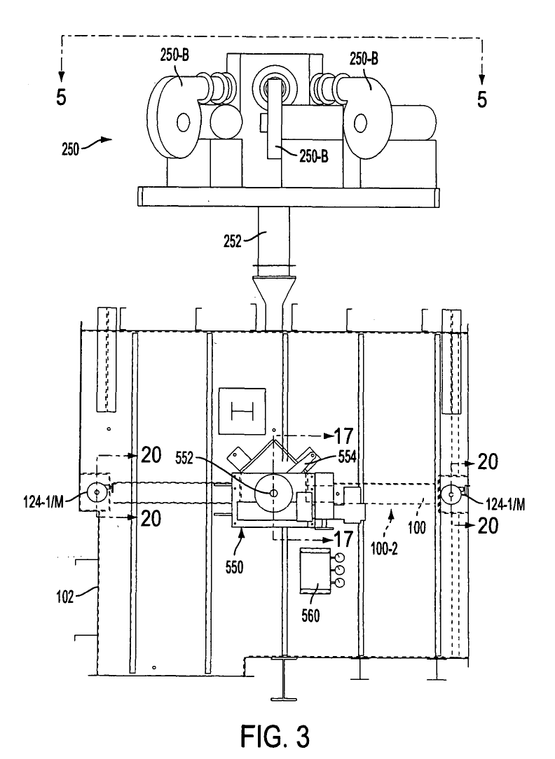

In this embodiment, the supply of air under pressure 250 comprises a plurality of blowers 250-B and heater 250-H which, as shown in FIGS. 3-5 are operatively connected with the first and second sets of seats through a series of conduits 252. Valving (including the porting in the rotatable members 124-1) and seal air shut-off valve 254 is provided to control the supply of air to the first and second sets of seal seats.

Air can be supplied to the first set of seats when the bi-plane blade 100 is in the first flow control position 100-1 then cut-off until the blade 100 reaches the second flow control position 100-2, and the rotatable members 124-1 are rotated to bring the seal seats into the appropriate sealing position with respect to the parallel edges of the bi-plane blade 100.

With SCR arrangements, the rotation of the bi-plane blade 100 from the first flow or by-pass position 100-1 to the second flow control position 100-2 where gas is directed into the gas treatment device 112 which contains expensive catalytic material, is determined based on atmospheric conditions. For example, the flow switch must be carried out when sufficient sunshine and/or climatic conditions arise that require the amount of NOx (for example) to be lowered to attenuate the formation of photochemical smog or the like.

During the transition it is necessary carefully to raise the temperature of the catalytic material in the gas treatment device 112 at a relatively low rate selected to avoid catalytic activity reducing damage thereto. In this connection, the heater which is included in the supply of air under pressure or air supply 250, is energized to heat the air supplied to the air curtains and the bi-plane blade is rotated slowly from the first position 100-1 to the second position 100-2.

With this embodiment, when the flow control element or bi-plane blade is in the by-pass position 100-1 the sealing effect which is provided by the b-plane blade 100, the seals and air curtains, establishes a toxic gas free zone 500 on the gas treatment device side of the bi-plane blade 100. This toxic gas free zone 500 is maintained by constantly supplying air into the air curtains at a pressure which is higher than the pressure of the gas which is introduced into the housing 102 through the first inlet port 104. This higher air curtain pressure prevents hot/noxious component containing gases from entering the toxic gas free zone 500.

The toxic gas free zone 500 enables inspection/maintenance to be carried out while hot noxious exhaust gas is still passing through the diverter.

When the flow control element or bi-plane blade 100 is in the second position 100-2 the seals and air curtains 128 prevent gases from leaking pass the flow control element 100 and ensures that all of the gases which should pass through the gas treatment device are so directed.

The following table sets forth examples of pressures relative to duct pressures (pressures prevailing at the first inlet port 104) which can be maintained by the air supply 250 in order to achieve the above-mentioned effects.

| | DUCT | | MIN. SEAL |
|---|---|---|---|
| DAMPER | PRESSURE | | CHAMBER |
| OPERATING | (IN W.G.) | | PRESS. |
| MODE | UP-STREAM | DOWN-STREAM | (IN W.G.) |
| FP-1 | | | |
| SCR ISOLATED | | | |
| (BYPASS MODE) | | | |
| NORMAL | +8 | 0 | +11 |
| ZERO LEAKAGE | +8 | 0 | +13 |
| FP-2 | +14 | +8 | +17 |
| SCR OPERATING | | | |
| NORMAL - SCR | | | |
| OPERATING | | | |
| PATH | | | |

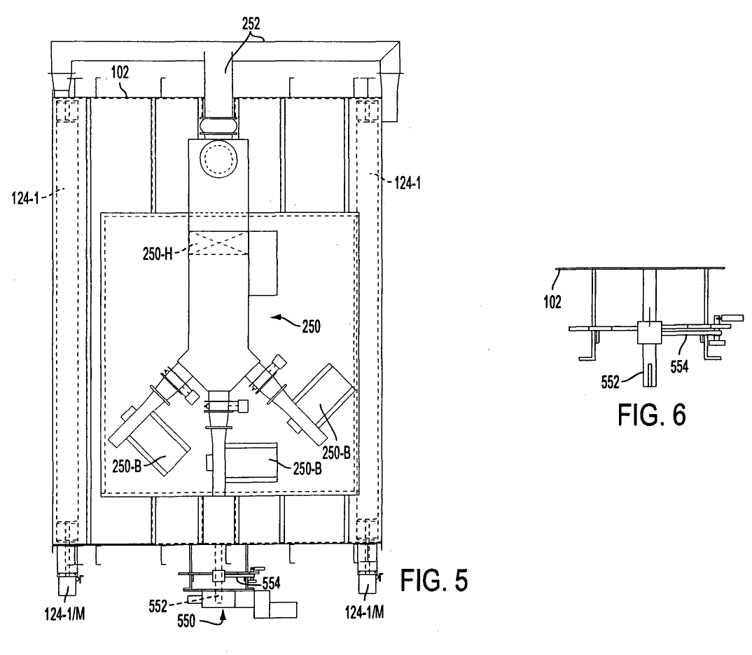

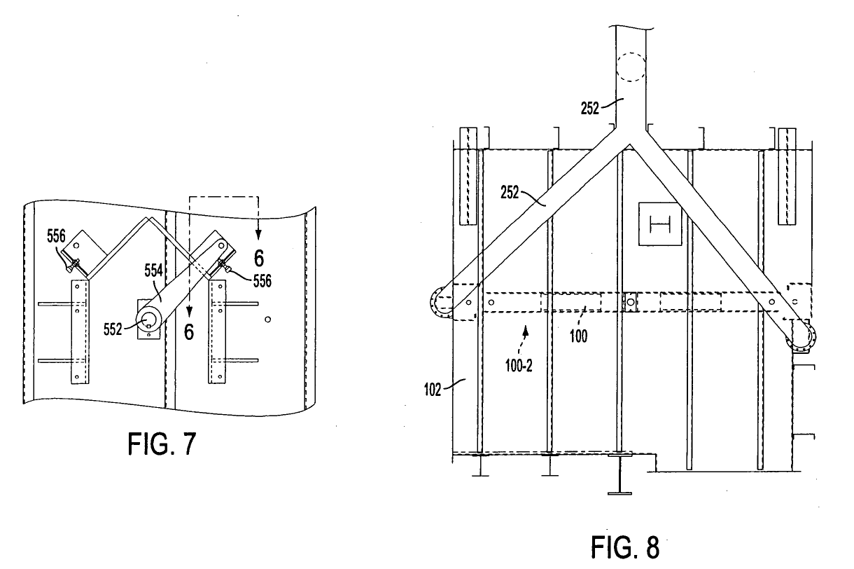

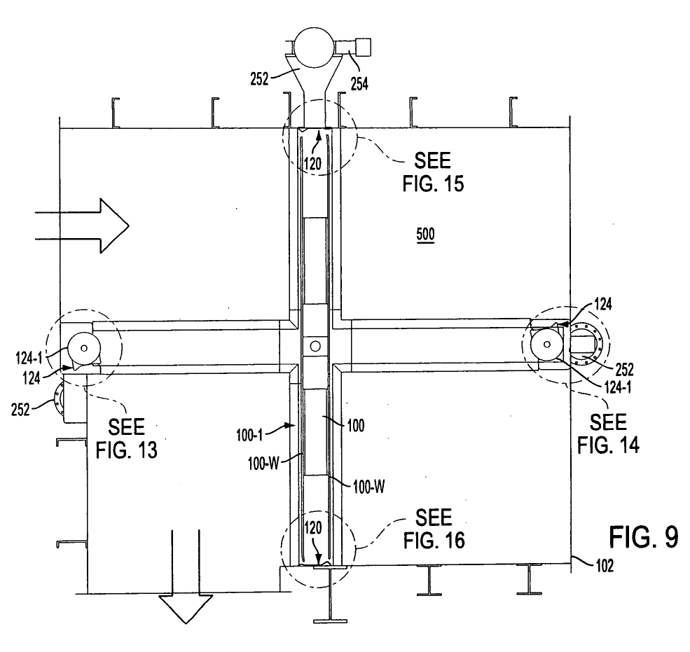

Movement of the flow control element 100 is controlled by a motor/step-down gearing arrangement 550 which is operatively connected with the shaft 552 of the flow control element. As shown in FIG. 5, the motor and step-down gearing 550 are operatively connected with a lower end of the shaft 552. A control lever 554 is connected to the shaft 552. This lever 554, as shown in FIGS. 6 and 7, is connected to the shaft 552 at a position between the motor/step-down gearing 550 and the housing 102.

The lever 554 moves synchronously with the flow control element (bi-plane blade) 100 and engages a stopper arrangement which includes adjustable stopper bolts 556 when the first and second flow control positions 100-1 and 100-2 are reached. The adjustable stopper bolts 556 ensures that the flow control element stops and engages the respective seal seats in a manner which obviates any pivotal movement that may invite misengagement between the flexible metal blades and the elongate apex ridge portions of the fixed and rotatable seal seats.

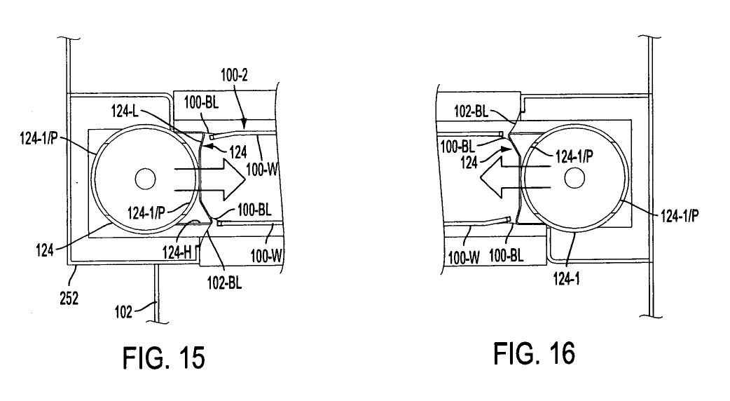

Motor control sensors (not shown) can also be arranged with the stopper bolts 556 to stop the motor of the motor/step-down gearing 550 and obviate any overstressing of the motor of the motor/step-down gearing 550 when the appropriate flow control position is established. A pressure/flow control arrangement 560 is, as shown in FIG. 3 located adjacent the motor/step-down gearing 550 so that motors 124-1/M that rotate the rotatable members 124-1 on which the second (rotatable) seal seats 124 are mounted either to the positions shown in 12 and 13 in preparation for movement of the flow control element from the second flow control position 100-2 toward the first flow control position 100-1 or from the positions shown in FIGS. 12 and 13 to the positions shown in FIGS. 15 and 16 upon the flow control element 100 reaching the second flow control position 100-2.

It will also be apparent that the ports 124-1P in the rotatable members 124-1 on which the rotatable valve seats 124 are mounted, are such that they are open to permit air from the source of air under pressure 250 to enter the interface between the rotatable valve seats 124 and the edges 100-P of the flow control element 100. Conversely, when the rotatable members 124-1 are rotated to the positions shown in FIGS. 12 and 13 the ports 124-1P are isolated from the interface in a manner which provides a flow control function. In this embodiment, frame seat seals 124-FS in the form of a flexible metal blade are provided to cooperate with the rotatable seal seats 124 in the manner illustrated in FIGS. 12, 13, 15 and 16.

Under these conditions the supply of air is controlled primary by the air seal shut-off valve 254 and/or the on/off controls of the blowers. Pressure sensors (not shown) are located at suitable points within the housing 102 to determine the pressure/pressure differentials which exist as a result of the first and second flow paths FP-1 and FP-2. The data provided by these sensors enables the control the number of blowers that are energized and/or the power with which they are energized in a manner to ensure that the required pressure/flow is maintained.

FIGS. 17-19 show details of the drive side (lower) and stub side (upper) ends of the shaft 552. These figures show the manner in which the jamb seals 100-JS engage the upper and lower walls of the housing 102.

As will be appreciated, annular air spaces 556 are provided between the upper and lower edges 100S of the flow control element 100 and the housing 102. These spaces are closed off by the jamb seals 100-JS which are mounted on a jamb seal plate 100-JSP and are angled with respect to the plate. Insulation cans 580 are disposed on the exterior of the housing 102 and are arranged to enclose the end portions of the shaft 552.

It is within the scope of this embodiment, to additionally supply non-heated air under pressure into the insulating cans 580 and to pressurize the spaces 556 to the degree that the bearing structures associated with the upper and lower ends of the shaft are cooled and so that additional air curtains are formed preventing gas passing by the edges 100-S of the flow control element 100.

In the above disclosed embodiment of the invention, the bi-plane blade 100 and housing 102 are made of boiler steel while the flexible seal members are formed of a suitable metal such as DDI C-276, for example.

Although the invention has been described with reference to only a limited number of embodiments, it will be understood that, given the preceding disclosure and the concepts that can be distilled therefrom, a person skilled in the art to which the present invention pertains or most closely pertains, would be able to readily envisage the variants and changes that are possible without departing from the scope of the appended claims.

For example, while the bi-plane blade or flow control element 100 has been shown rotatable about a vertical axis, the invention is not so limited and the axis can be rendered horizontal or angled, without departing from the scope of the invention. Further, while air has been show supplied to the seal seats, it is possible that air is supplied at a central point such through a passage structure which is associated with the shaft about which the flow control element is rotatable.

1. A gas flow diverter comprising:
a housing having first and second inlets and first and second outlets;
a flow control element having first and second spaced walls each having first and second opposed edges, the flow control element being disposed in the housing and pivotal about an axis between first and second flow control positions,
the first flow control position partitioning the housing so that the first inlet is isolated from the first outlet and the second inlet is isolated from the second outlet and so that a first flow path is established between the first inlet and the second outlet,
the second flow control position partitioning the housing so that the first inlet is isolated from the second outlet and the second inlet is isolated from the second outlet and so that a second flow path is established;
first and second pairs of seal seats against which the first and second opposed edges of the flow control element are operatively engageable when the flow control element assumes the first and second flow control positions respectively; and
an air supply for supplying air under pressure into a space defined between the first and second walls to establish air flows between at least the first and second edges of the flow control element and the first pairs of seats when the flow element is in the first flow control position and between the first and second edges of the flow control element and the second pair of seats when the flow control element is in the second flow control position.

2. A gas flow diverter as set forth in claim 1, wherein a toxic gas free zone is established in the housing between the flow control element in the first flow control position and the second inlet and second outlet.

3. A gas flow diverter as set forth in claim 1, wherein
the first outlet is adapted for connection with a noxious component treatment device and to deliver gas containing a noxious component into the treatment device,
wherein the second inlet is adapted to deliver gas which has passed through the noxious component treatment device into the housing,
wherein the first inlet is adapted to receive gas containing noxious component, and
wherein the second outlet is adapted for exhausting gas to the ambient atmosphere.

4. A gas flow diverter as set forth in claim 1, wherein the air under pressure from the air supply has a pressure which is greater than the pressure in the first inlet port.

5. A gas flow diverter as set forth in claim 1, wherein the first and second spaced walls are offset from one another so that the flow control element has an essentially trapezoidal cross-section.

6. A gas flow diverter as set forth in claim 1, wherein each of the first and second pairs of seal seats have a stepped configuration wherein a first step is lower than a second step.

7. A gas flow diverter as set forth in claim 6, wherein the first and second walls respectively have first and second opposite edges which are respectively provided with flexible seal members and wherein the flexible seal members on each of the leading edges of the first and second walls with respect to the direction of rotation of the flow control member about the axis of rotation, is such as to miss the respective first low steps of the first pair of seal seats and to engage the respective second high steps, and wherein the seal members on the trailing edges of the first and second walls with respect to the direction of rotation is such as to engage the first lower steps.

8. A gas flow diverter as set forth in claim 6, wherein the first and second walls respectively have first and second opposite edges which are respectively provided with flexible seal members and wherein the flexible seal members on each of the leading edges of the first and second walls with respect to the direction of rotation of the flow control member about the axis of rotation, is such as to miss the respective first low steps of the second pair of seal seats and to engage the respective second high steps, and wherein the seal members on the trailing edges of the first and second walls with respect to the direction of rotation is such as to engage the first lower steps.

9. A gas flow diverter as set forth in claim 8, wherein the second pair of seats is arranged so that each seat is rotatable from a first position wherein the first and second steps are directed toward an axis about which the flow control element is rotatable and a second position wherein the first and second steps are directed away from the axis.

10. A gas flow diverter as set forth in claim 1, wherein the air supply comprises:
at least one blower; and
conduits for supplying air to the first and second seats; and
a flow control arrangement which directs the air supplied into the conduits to the first set of seal seats when the air flow control element is in the first flow control position and to the second set of seal seats when the flow control element is in the second flow control position.

11. A gas flow diverter as set forth in claim 10, wherein the air supply includes a heater for heating the air which is supplied thereby.

12. A gas flow diverter comprising:
a flow control element which is rotatable about an axis of rotation between a first flow directing position and a second flow directing position;
first and second sets of seal seats disposed to cooperate with opposed edges of the flow control element when the flow control element is in the first and second flow control directing positions, respectively; and
an air supply which supplies air under pressure to a first interfaces between the first set of seal seats and the flow control element when the flow control element is in the first flow control position and to second interfaces between the second set of seal seats and the flow control element when the flow control element is in the second flow control position.

13. A gas flow diverter as set forth in claim 12,
wherein the flow control element comprises a blade member comprising first and second spaced walls, and
wherein the first and second spaced walls of the blade member are offset with respect to each other and so that the blade member has an essentially trapezoidal cross-section when taken normally to the axis of rotation.

14. A gas flow diverter as set forth in claim 13, wherein the blade has an essentially rectangular cross-section when taken parallel to the axis of rotation.

15. A gas flow diverter as set forth in claim 12, wherein the first and second spaced walls of the blade member respectively have first and second sets of opposed edges which are provided respectively with first and second sets of flexible seal members.

16. A gas flow diverter as set forth in claim 12, wherein the first and second sets of seal seats have a stepped configuration wherein each steps has a high ridge portion and a low ridge portion.

17. A gas flow diverter as set forth in claim 12, wherein the air supply selectively supplies air to the interfaces between the first and second interfaces in response to flow control element flow control positions respectively.

18. A gas flow diverter as set forth in claim 12, wherein
the flow control element is disposed in a housing having a first inlet, a first outlet, a second inlet and a second outlet, wherein the first flow directing position of the flow control element places isolates the first outlet-from the first inlet, isolates the second inlet from the second outlet and places the first inlet and the first outlet in communication with one another, wherein the second flow directing position of the flow control element places the first inlet in communication with the first outlet and the second inlet in communication With the second outlet.

19. A gas flow diverter as set forth in claim 12, wherein the air supply supplies air under a pressure which is greater than a gas pressure at the first inlet.

20. A gas flow diverter as set forth in claim 18, wherein a toxic gas free zone is established in the housing between the flow control element and the second inlet and the second outlet when the flow control element is in the first flow directing position.

21. A method of controlling gas flow comprising the steps of:
dispositioning a flow control element in a first flow control position wherein a first flow path, which by-passes an exhaust gas treatment device, is established and wherein opposed edges of the flow control element juxtapose a first set of seal seats;
introducing air under pressure into interfaces defined between the opposed edges of the flow control element and the pair of seal seats which are disposed in a housing in which the flow control element is pivotally disposed, and establishing first air flows which form a first air curtain arrangement;
rotating the flow control element from the first flow control position to a second flow control position wherein a second flow path, which directs gas flow through the exhaust gas treatment device, is established and wherein the opposed edges of the flow control element juxtapose a second set of seal seats; and
introducing air under pressure into interfaces defined between the opposed edges of the flow control element and the second pair of seal seats establishing second air flows which form a second air curtain arrangement.

22. A method as set forth in claim 21, further comprising establishing a toxic gas free zone in a housing in which the flow control element is disposed by setting the flow control element in the first flow position and using the first flow control element and the first and second air curtain arrangements to exclude gas from a portion of the housing partitioned off by the flow control element.

23. A method as set forth in claim 21, further comprising using a flow control element which has first and second spaced walls and wherein the walls are arranged so that a cross section taken normally to an axis about which the flow control element is disposed is essentially trapezoidal.

24. A method as set forth in claim wherein 21, the first and second sets of seal seats are stepped so as to each have a high ridge and a low ridge and wherein air is introduced between the high and low ridges into the interfaces.
